(19) United States
(12) Patent Application Publication
(10) Pub. No.: US 2014/0363058 A1
(43) Pub. Date: Dec. 11, 2014

(54) Systems And Methods For Uniquely Identifying An Individual

(71) Applicant: EyeD, LLC, Denver, CO (US)

(72) Inventors: Jennifer L. Emmett, Denver, CO (US); Stacy E. Cason, Denver, CO (US); Lori Lemmen, Denver, CO (US); Mark Karl Gengozian, Denver, CO (US); Tom Medl, San Diego, CA (US)

(73) Assignee: EyeD, LLC

(21) Appl. No.: 14/298,694

(22) Filed: Jun. 6, 2014

Related U.S. Application Data
(60) Provisional application No. 61/832,729, filed on Jun. 7, 2013.

(51) Int. Cl. G06K 9/00; G06K 9/62

(52) U.S. Cl. CPC G06K 9/0061; G06K 9/00604; G06K 9/6212
USPC 382/117; 382/115

(57) ABSTRACT

A system and method are provided for uniquely identifying an individual. An authentication device captures a biometric scan for the purpose of verifying the identity of an individual, and then, an authentication server determines whether the captured biometric image matches a master image. Some embodiments involve the execution of a digital subtraction process, more specifically, normalizing and aligning the biometric image in determining whether or not there is a match. After determining there is a match between the biometric scan and the master image, a user is allowed access or a transaction is allowed to occur.

### RELATED APPLICATIONS

This application claims priority to U.S. Patent Application Ser. No. 61/832,729, titled “System and Method for Uniquely Identifying Individuals,” filed Jun. 7, 2013, and incorporated herein by reference.

### BACKGROUND

Fraudulent transactions are common among the banking industry. Other transactions susceptible to fraud include pharmaceutical transactions, access to computers and access to homes protected by security systems, among others. Industries more susceptible to fraud have taken steps to improve the security of transactions but security problems still exist. For example, credit card companies require a signature on the receipt in order to process a transaction. Debit cards are often used in conjunction with a Personal Identification Number (PIN). Personal and workplace computers often require unique passwords to access the computer. Pharmacies may require personal identification, such as a valid photo ID (e.g. driver's license, passport, etcetera), in order to pick-up or purchase prescription medication.

These techniques have not been successful at eliminating the occurrence of fraudulent transactions. Unfortunately, criminals have found it easy to “crack codes” in order to gain access to another's bank accounts, computers or even homes. This is very dangerous and devastating for the person whose accounts have been hacked. Because it is so easy to forge a signature or crack a code to gain access to areas that would otherwise be off-limits, there is a need for a method of authorization that is uniquely tied to an individual and that cannot be forged or “cracked”.

### SUMMARY OF THE INVENTION

The following present a simplified summary of the invention in order to provide a basic understanding of some aspects of the invention. This summary is not an extensive overview of the invention. Its sole purpose is to present some concepts of the invention in a simplified form as a prelude to the more detailed description presented elsewhere.

According to one embodiment, a transaction station is a gasoline pump that includes a processing device and a visual scanning device to take a scan of a customer's eye for comparison with a picture stored in a remote processing device, such as a computer operated by a credit card company, connected via a network (e.g. the interne). The remote processing device invokes an application to compare images of a person's iris to a master image. Completion of a transaction is then based upon whether or not the images match. In another embodiment, the point-of-sale is a cellular phone wherein credit card information is entered by the cell phone user to complete a transaction and the cellphone is equipped with iris scanning technology. In yet another embodiment, an ATM is equipped with iris scanning technology.

In each embodiment, the image receiver captures an image of a user's iris for comparison with an image stored in a database corresponding to that user's name or other identifiable information (i.e. name, date of birth, credit card number, social security number et cetera). The image captured at the point-of-sale is transmitted over a network using means known in the industry to a remote processing device. The remote processing device receives a request from the point-of-sale device to compare two images. Comparing the images allows a remote processing device to authorize the identity of the user without the need for signatures, PINs or passwords.

In one embodiment, a secure authentication server uniquely identifies an individual and includes a processor and a memory storing machine readable instructions that are executable by the processor to provide the capability of: receiving, from a remote authentication device, an authentication request comprising an account ID associated with the individual and a biometric test image captured of the individual; digitally subtracting a master image, stored within the memory in association with the account ID, from the biometric test image to generate a high contract test image; processing the high contract test image to determine a percentage match of the biometric test image to the master image; and sending the percentage match to the remote authentication device.

In another embodiment, an authentication device uniquely identifies an individual and includes a processor, and a memory communicatively coupled with the processor. The memory stores machine readable instructions that when executed by the processor provide the authentication device capable of: receiving an account ID corresponding to the individual requiring authentication; capturing a biometric image of the individual; sending the account ID and the biometric image to a remote authentication server; and receiving, from the remote authentication server, a match value indicative of confidence in the individual matching the account ID.

In another embodiment, a method uniquely identifies an individual. An authentication request including an account ID associated with the individual and a biometric test image captured of the individual is received from a remote authentication device. A master image, stored within the memory in association with the account ID, and the biometric test image are processed to determine a match value. The match value is then sent to the remote authentication device.

In another embodiment, a method uniquely identifies an individual. An authentication device captures a biometric image of the individual. The biometric image and an associated account ID is encrypted in an authentication request message that is sent from the authentication device to an authentication server that is remote from the authentication device. The authentication device received an authentication response from the authentication server; that is decrypted to determine a match result. A signal indicative of the match value being greater than a predefined threshold is output.

In another embodiment, a method provides a service for individual identification. A server receives an authentication request message containing a test biometric image and an account ID from a remote authentication device. A master biometric image is retrieved from a database of the server based upon the account ID. A match value indicative of a percentage match between the test biometric image and the master biometric image is determined and sent to the remote authentication device in reply to the authentication request message. A cost value Is added within the server to a cost accumulator associated with a client.

### BRIEF DESCRIPTION OF THE FIGURES

FIG. 1 shows one exemplary system for uniquely identifying an individual, in an embodiment.

FIG. 2 shows the system of FIG. 1 in further exemplary detail.

FIG. 3 is a data flow diagram illustrating exemplary operation of the system of FIGS. 1 and 2, in an embodiment.

FIG. 4 is a flowchart illustrating one exemplary method implemented in an authentication device for uniquely identifying an individual, in an embodiment.

FIG. 5 is a schematic showing exemplary dataflow within the system of FIG. 1 during execution of the authentication software of FIG. 2 by the processor, in an embodiment.

FIG. 6 is a flowchart illustrating one exemplary method for uniquely identifying an individual, in an embodiment.

FIG. 7 shows one exemplary test image captured by the authentication device of FIG. 1.

FIG. 8 shows one exemplary aligned image generated by the image aligner of FIG. 5.

FIG. 9 shows one exemplary masked image generated by the image masker of FIG. 5.

FIG. 10 shows one exemplary histogram generated from the masked image of FIG. 9.

FIG. 11 shows one exemplary normal image generated by the image normalizer of FIG. 5.

FIG. 12 shows one exemplary blanked image generated by the image blanker of FIG. 5.

FIG. 13 shows one exemplary log/polar image generated by the iris isolator of FIG. 5.

FIG. 14 shows one exemplary iris image generated by the image masker of FIG. 5.

FIGS. 15A and 15B show exemplary difference images generated by the digital subtractor of FIG. 5.

FIG. 16 is a schematic showing one exemplary cloud based system for uniquely identifying an individual as a service, in an embodiment.

FIG. 17 shows the cloud based secure authentication server of the system of FIG. 16 in further exemplary detail.

FIG. 18 is a flowchart illustrating one exemplary method for accumulating a cost representative of a service provided by the system of FIG. 16, in an embodiment.

### DETAILED DESCRIPTION OF THE EMBODIMENTS

Iris scanning may provide a unique solution that could reduce the amount of fraudulent transactions occurring today. A person's iris is unique to him or her, cannot be stolen, and when compared to a previous iris scan of the same person, and provide an accurate means for identifying a particular individual.

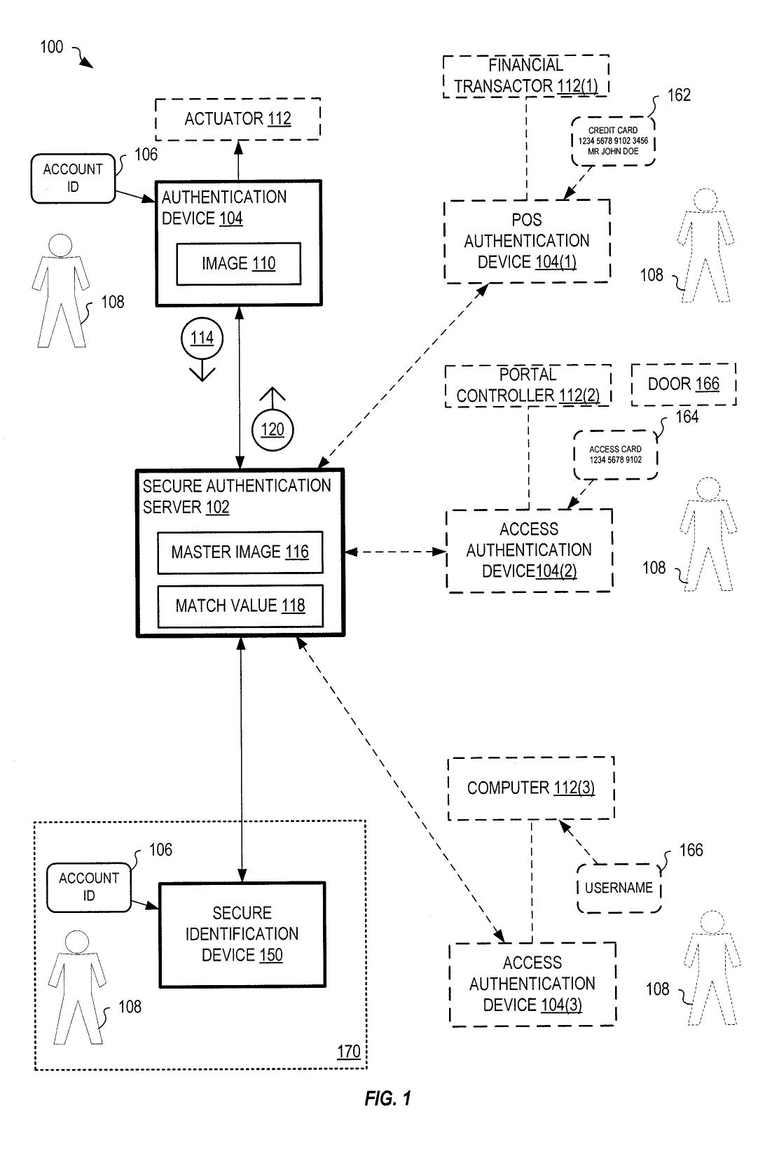

FIG. 1 shows one exemplary system 100 for uniquely identifying an individual 108. System 100 includes a secure authentication server 102 in communication with at least one authentication device 104. Authentication device 104 may be remote from server 102 and connects to server 102 via one or more wired and/or wireless computer networks that may include the Internet.

Authentication device 104 may also communicate with an actuator 112, external to system 100, which performs a certain function in response to identification of an individual by system 100. For example, actuator 112 may control opening of a door, payment of money, computer access (e.g., login authorization), start a device, trigger a device, and so on. In one embodiment, authentication device 104 and actuator 112 are combined into a single unit. Authentication device 104 includes a biometric imager (e.g., one or more of a scanner, sensor, a camera, and recording device) for capturing an image 110 of a biometric feature (e.g., an iris, a finger print, palm print, etc.) of individual 108. Authentication device 104 also receives (e.g., from actuator 112 or using a scanner within authentication device 104) an account ID 106 for which identification of individual 108 is required.

System 100 may also include a secure identification device 150 that is similar to authentication device 104 but is operated under greater security, such as within a secure and/or trusted area 170. Secure identification device 150 is used by an authorized operator to capture a biometric master image 116 of individual 108 and account ID 106, and stores biometric master image 116 within server 102 in association with account ID 106. That is, account ID 106 may be used to identify biometric master image 116 within server 102.

Upon receiving an authentication request 114, secure authentication server 102 retrieves master image 116 based upon account ID 106 and processes image 110 against master image 116 to determines a match value 118 that is indicative of confidence in image 110 matching master image 116. In one embodiment, match value 118 is a percentage where 100% indicates absolute confidence that image 110 matches master image 116 and 0% indicates no confidence that image 110 matches master image 116. Thus, match value 118 defines confidence in individual 108 being present at authentication device 104. Authentication device 104 may provide match value 118, or a representation thereof, to actuator 112, wherein actuator 112 may, or may not take further action, based upon this confidence.

Each instantiation of system 100 may have a different confidence requirement for matching test image 110 to master image 116. Alternatively, an entity such as a credit card company may require higher confidence in authentication for higher value transactions, but allow lower confidence authentication for lesser value transactions. For example, where a customer uses a credit card for a $10 transaction within a store, system 100 may determine a match quickly by comparing a single test image 110 to master image 116. Where a transaction is for $4000, system 100 may process multiple test images 110 against one or more master images 116 of one or both eyes to generate match value 118, wherein match value 118 provides a higher confidence in the purchaser being authentic. Thus, system 100 may quickly provide authentication response 120 for smaller purchases, when higher throughput at a store check-out is desired, while taking slightly longer to generate authentication response 120 for larger transaction amounts. In one embodiment, the entity requiring authentication may specify thresholds and required confidence levels for use by system 100. For example, authentication device 104 may include a confidence requirement level within authentication request 114 together with multiple test images 110. In an alternate embodiment, authentication device 104 may automatically adjust an authentication threshold 260, which determines whether match value 118 returned in authentication response 120 indicates pass or fail for example, based upon a determined level of authentication requirements, such as a transaction value. In one embodiment, authentication threshold 260 is predefined. In another embodiment, authentication threshold 260 is stored within database table 208 in association with account ID 106, wherein authentication threshold 260 is returned to authentication device 104 within authentication response 120, thereby allowing the confidence level to be defined for each account ID.

In one example of operation, authentication device 104 captures biometric image 110 of individual 108, receives an associated account ID 106, and forms an authentication request 114 that is sent to secure authentication server 102. Server 102 compares biometric image 110 of authentication request 114 with a biometric master image 116 that is associated with account ID 106, to determine a match value 118. Server 102 then sends, in reply to authentication request 114, an authentication response 120 indicative of match value 118 to authentication device 104. Authentication device 104 sends match value 118, or a representation thereof, to actuator 112, which in turn performs an action (e.g., opens a door) that requires unique identification of individual 108 when match value 118 indicate a sufficient probability that individual 108 is present at authentication device 104.

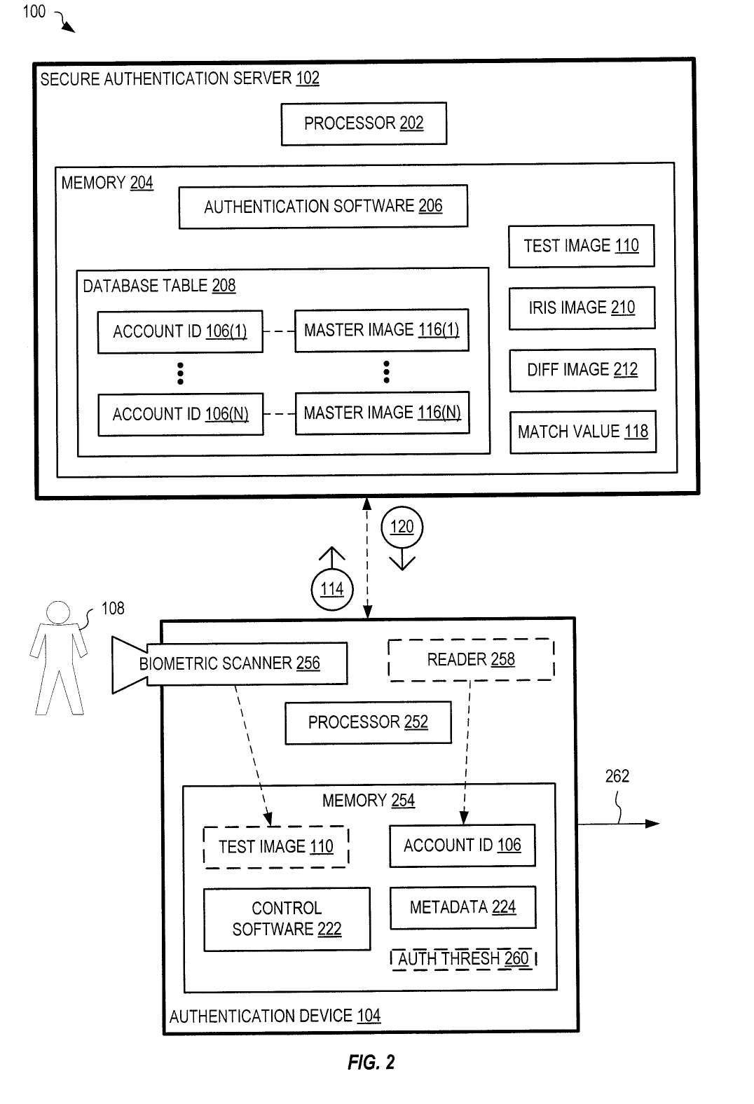

FIG. 2 shows system 100 of FIG. 1 in further exemplary detail. Server 102 is shown with a processor 202 and a memory 204 storing authentication software 206 that includes machine readable instructions that when execute by processor 202 provide functionality of server 102 described herein. Memory 204 is also shown with a relational database table 208 storing a plurality of account IDs 106(1)-(N) in association with a plurality of master images 116(1)-(N), respectively. Each master image 116 may represent one or more reference images associated with account ID 106. Master image 116(1) may represent one or more images, depending upon the biometric used for identifying individual 108. In one embodiment, where iris biometrics are used by system 100 to identify individual 108, master image 116 includes two images, one of the iris of the left eye of individual 108 and one of the iris of the right eye of individual 108. Where fingerprint biometrics are used with system 100 to identify individual 108, master image 116 includes ten images, one image of each finger and thumb print. Where multiple images are stored within master image 116, authentication software 206 automatically matched test image 110 to the appropriate image within master image 116.

Authentication device 104 includes a processor 252, a memory 254, control software 222, a biometric scanner 256, and optionally a reader 258 for reading account ID. Control software 222 includes machine readable instructions that when executed by processor 252 provides control of biometric scanner 256, reader 258 (if reader 258 is included), and communication with secure authentication server 102.

In one embodiment, reader 258 is an RFID reader that reads account ID 106 from an RFID tag, such as included within a security card used for entry through a secure door. In another embodiment, reader 258 is a bar code scanner for reading account ID 106 from a bar code of a security card, such as used for entry through a secure door. In another embodiment, reader 258 is a magnetic card reader for reading account ID 106 from a banking card for example. In another embodiment, reader 258 is a smart card reader for reading account ID 106 from a smart card. Authentication device 104 may include multiple readers 258 for reading account ID from any of the above mentioned devices. For example, where authentication device 104 is configured as a point of sale (POS) device, authentication device 104 may include both a magnetic card reader and a smart card reader.

Biometric scanner 256 is for example one of an iris scanner (e.g., a camera), a fingerprint scanner, a facial scanner (e.g., a camera), an EKG sensor, and an ECG sensor. That is, although iris scanning is used in the examples described herein, other biometric images and signal may be similarly processed and matched by system 100.

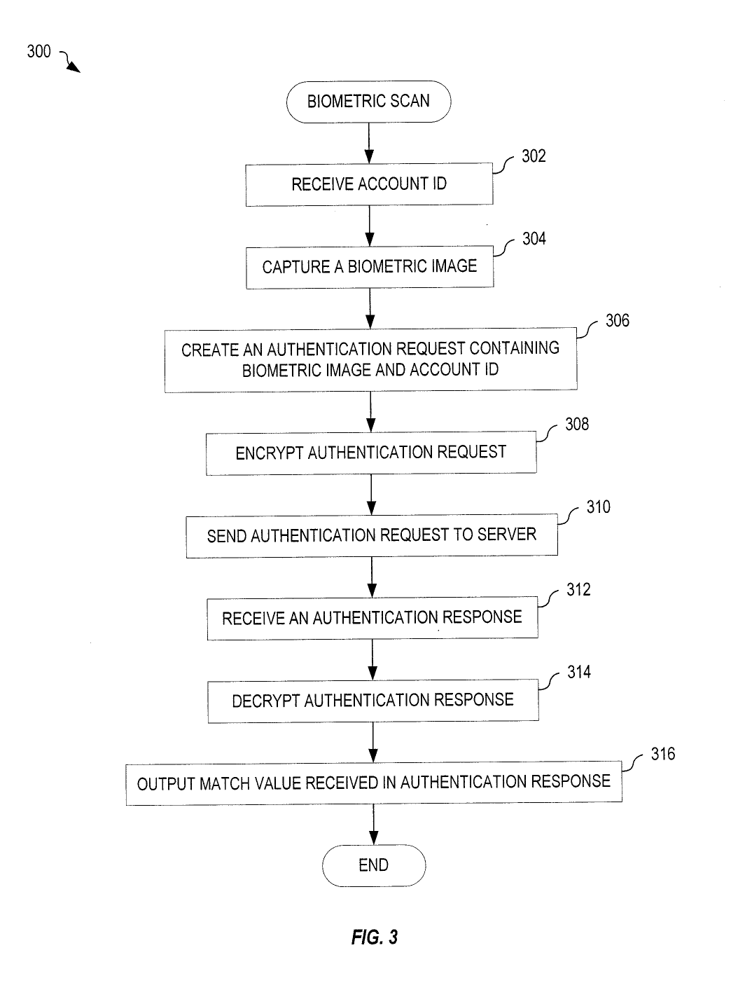

FIG. 3 is a flowchart illustrating one exemplary method 300 for uniquely identifying an individual, in an embodiment. Method 300 is for example implemented within control software 222 of authentication device 104. In step 302, method 300 receives an account ID. In one example of step 302, individual 108 presents a payment card 162 to reader 258 of authentication device 104, wherein account ID 106 is read from the payment card. In step 304, method 300 captures a biometric image. In one example of step 304, processor 252 controls biometric scanner 256 to capture an iris image of individual 108. In step 306, method 300 creates an authentication request containing the biometric image and the account ID. In one example of step 306, processor 252 creates authentication request 114 containing test image 110 and account ID 106.

In step 308, method 300 encrypts the authentication request of step 306. In one example of step 308, processor 252 utilizes an encryption algorithm to encrypt authentication request 114.

In step 310, method 300 sends the authentication request to the server. In one example of step 310, processor 252 sends authentication request 114 to secure authentication server 102. In step 312, method 300 receives an authentication response. In one example of step 312, authentication device 104 receives authentication response 120 from secure authentication server 102.

In step 314, method 300 decrypts the authentication response. In one example of step 314, processor 252 utilizes a decryption algorithm to decrypt authentication response 120.

In step 316, method 300 outputs 262 a match value. In one example of step 316, processor 252 outputs match value 118, received in authentication response 120, to actuator 112. In another example of step 316, control software 222 compares the returned match value 118 to authentication threshold 260 and outputs 262 a pass or fail indication. This pass or fail indication may or may not trigger another device or may enable, or reject, a transaction. Method 300 then terminates. Method repeats to authenticate each received account ID 106.

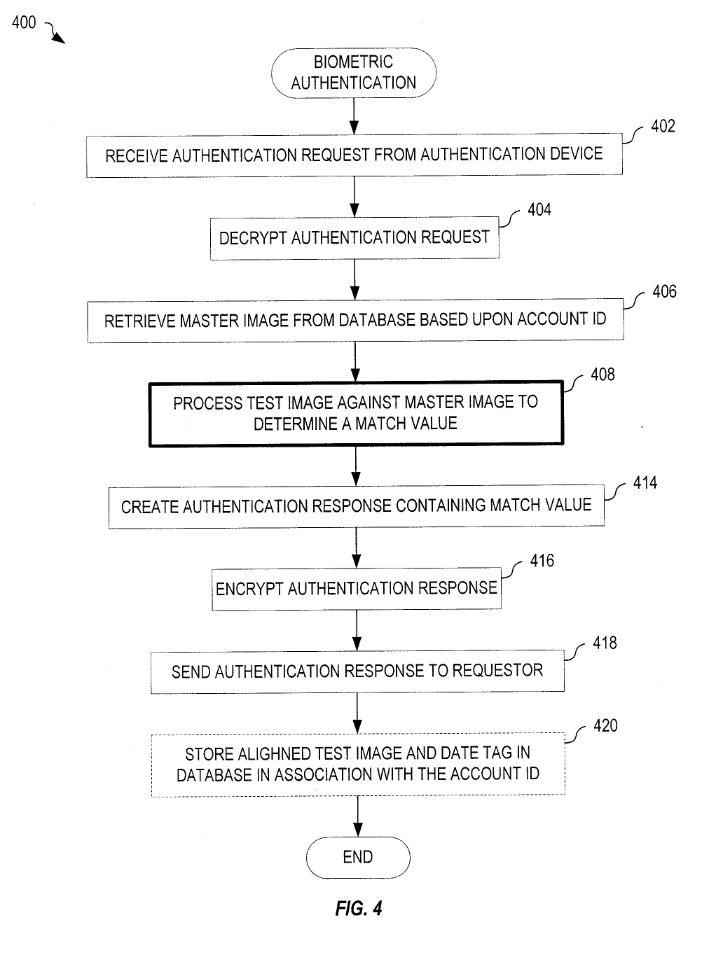

FIG. 4 is a flowchart illustrating one exemplary method 400 for uniquely identifying an individual, in an embodiment. Method 400 is for example implemented within authentication software 206 of secure authentication server 102 of FIG. 1.

In step 402, method 400 receives an authentication request from an authentication device. In one example of step 402, secure authentication server 102 receives authentication request 114, generated by method 300 of FIG. 3, from authentication device 104.

In step 404, method 400 decrypts the authentication request. In one example of step 404, processor 202 utilizes a decryption algorithm to decrypt authentication request 114.

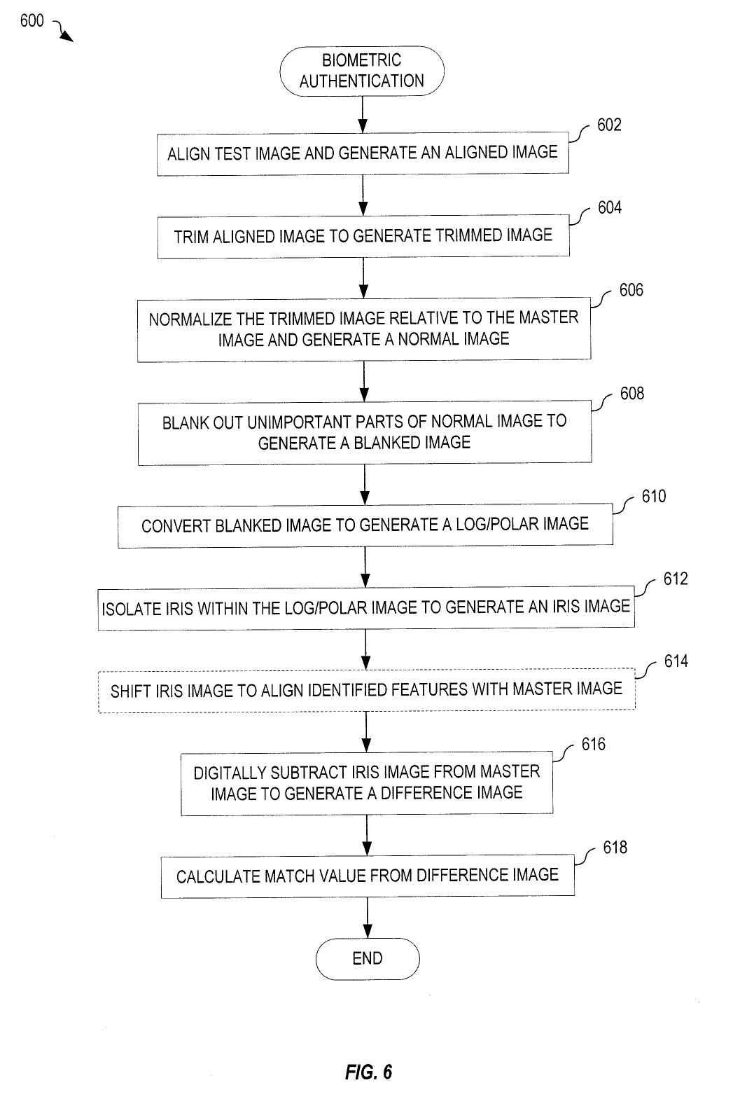

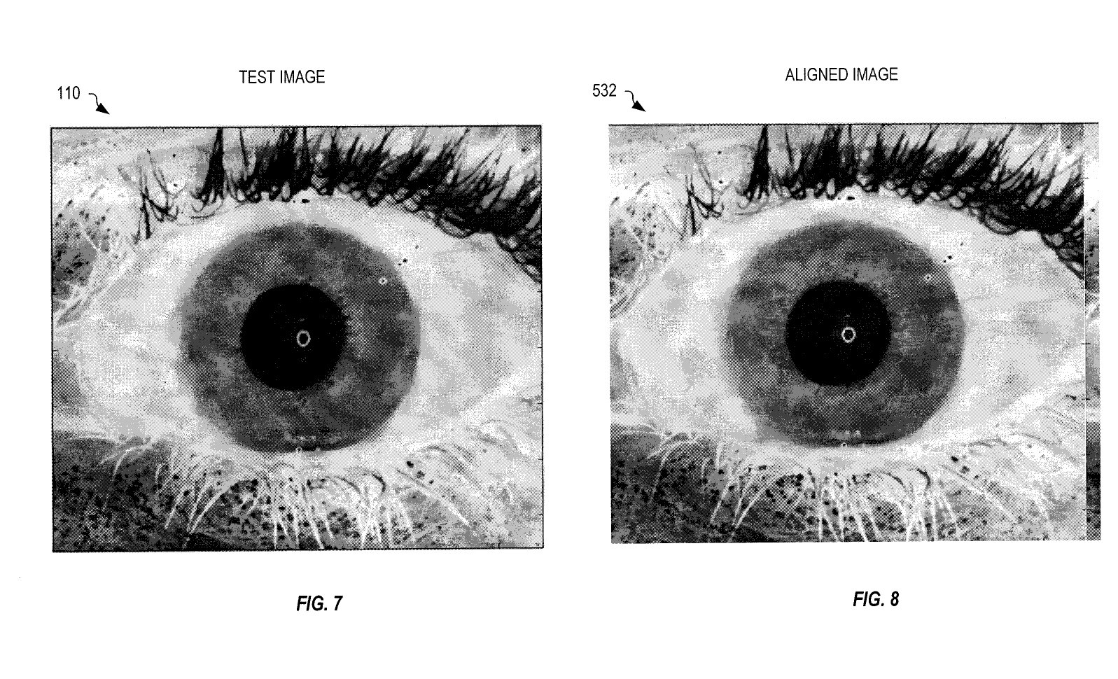

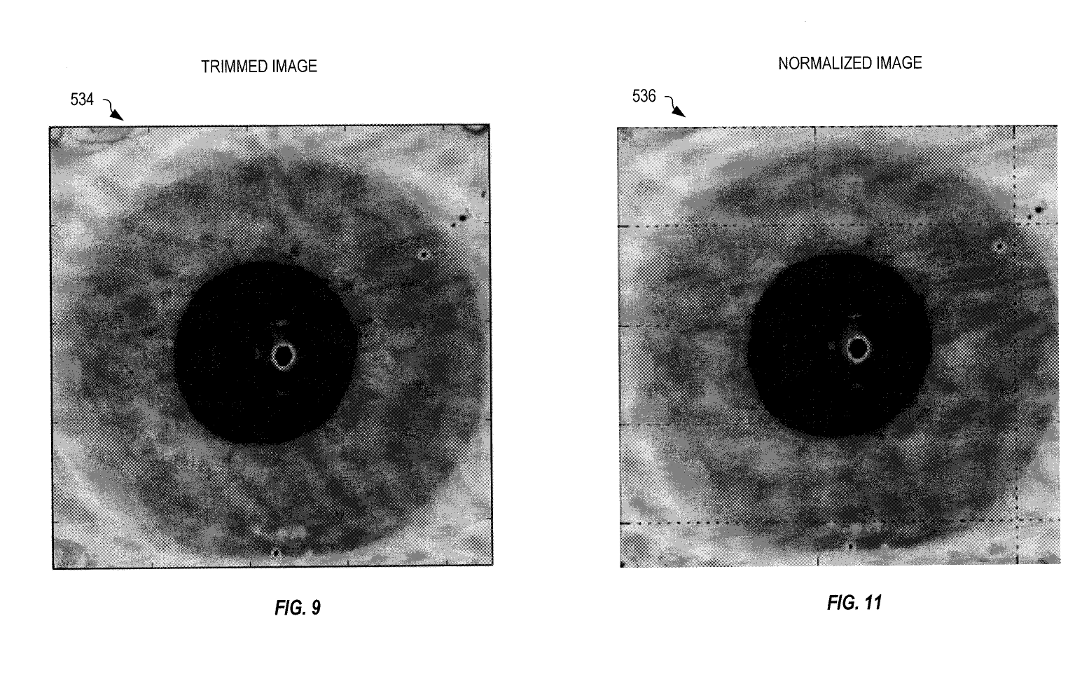

In step 406, method 400 retrieves a master image from a database based upon the account ID received in the authentication request. In one example of step 406, processor 202 retrieves master image 116(1) from database table 208 based upon account ID 106 received in authentication request 114. In step 408, method 400 processes the test image against the master image and determines a match value. In one example of step 408, authentication software 206 processes test image 110 against master image 116 and determines match value 118 that is indicative of test image 110 being take of the same eye that master image 116 was taken. Step 408 is shown in further exemplary detail in FIG. 6. In step 414, method 400 creates an authentication response containing the match value. In one example of step 414, processor 202 creates authentication response 120 containing match value 118.

In step 416, method 400 encrypts the authentication response. In one example of step 416, processor 202 utilizes an encryption algorithm to encrypt authentication response 120.

In step 418, method 400 sends the authentication response to the requestor. In one example of step 418, processor 202 sends authentication response 120 to authentication device 104.

Step 420 is optional. If included, in step 420, method 400 stores the aligned test image and a data tag in the database in association with the account ID. In one example of step 420, processor 202 stores one or both of test image 110 and an iris image 210 (generated by method 600, FIG. 6) together with a current time tag in database table 208 in association with account ID 106. Method 400 then terminates. Method 400 is invoked for each received authentication request 114.

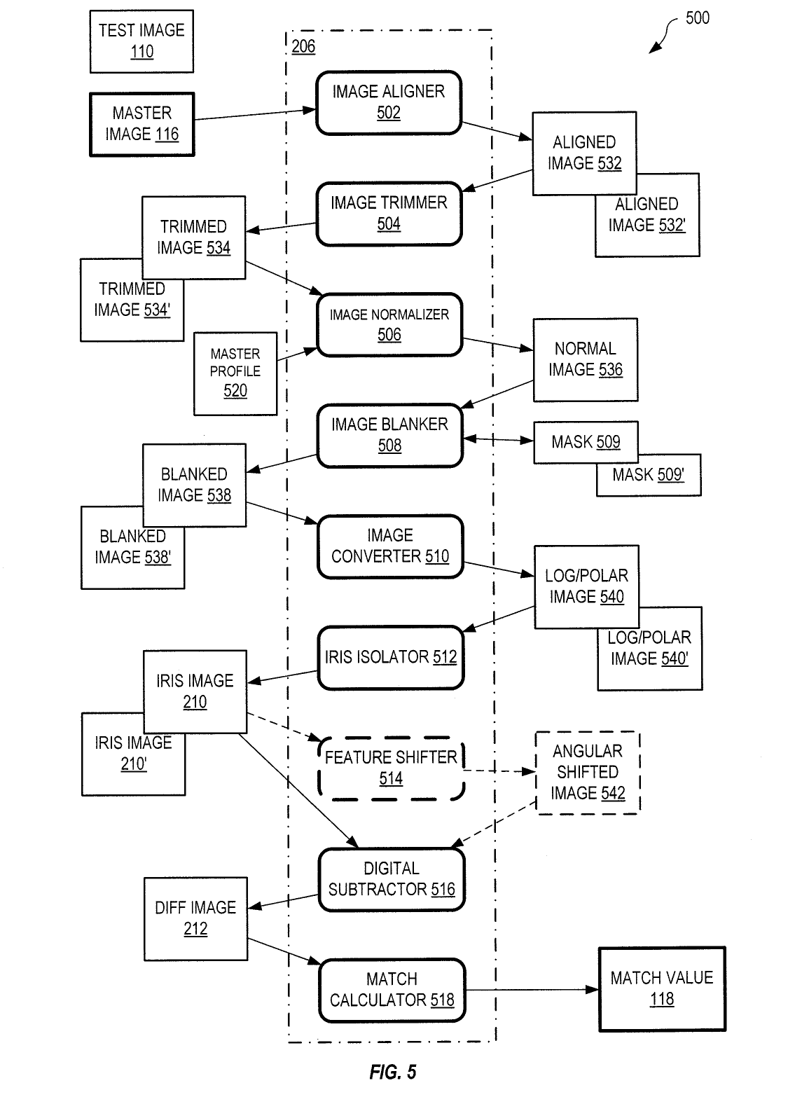

FIG. 5 is a schematic showing exemplary dataflow within system 100 of FIG. 1 during execution of authentication software 206 by processor 202. FIG. 6 is a flowchart illustrating one exemplary method 600 for authenticating a captured test image 110 against master image 116. FIGS. 5 and 6 are best viewed together with the following description. In the following example, processing of test image 110 is illustrated, however, master image 116 may be similarly processed such that like images are compared.

Method 600 is implemented within authentication software 206 for example. Authentication software 206 has a plurality of modules, including an image aligner 502, an image trimmer 504, an image normalizer 506, an image blanker 508, an image converter 510, an iris isolator 512, a feature shifter 514, a digital subtractor 516, and a match calculator 518. These modules are illustrative and functionality of two or more modules may be combined into a single module without departing from the scope hereof.

In step 602, method 600 aligns the test image and generates an aligned image. In one example of step 602, image aligner 502 aligns test image 110 based upon a determined position of a pupil within the image and generates aligned image 532, an example of which is shown in FIG. 8. In one embodiment, test image 110 is captured by authentication device 104 and has associated metadata 224 that is determined by one or both of biometric scanner 256 and control software 222. Metadata 224 for example includes an approximate position of a center of a pupil of the eye captured within test image 110. In another embodiment, image aligner 502 includes software to detect a pupil within test image 110 and then determine a center of that pupil. Image aligner 502 then operates to center the imaged eye in test image 110 within an aligned image 532.

In step 604, method 600 trims (or masks) the aligned image to generate a trimmed image. In one example of step 604, image trimmer 504 processes aligned image 532 to generate trimmed image 534, wherein edges of aligned image 532 are removed such that trimmed image 534 contains minimal imagery outside of the iris. In one embodiment, image trimmer 504 utilizes a fixed size mask to trim aligned image 532 to generate trimmed image 534. In another embodiment, image trimmer 504 trims aligned image 532 based upon detected edges of the iris in the image, such that trimmed image 534 contains the smallest amount of unwanted imagery (e.g., eyelids, eyelashes, etc.) while maintaining all imagery if the iris. Other techniques may be used to trim aligned image 532 without departing from the scope hereof. For example, a mask may be generated based upon detected edges of the iris within aligned image 532 and applied to aligned image 532 to mask out pixels of unwanted imagery. Ideally, image trimmer 504 maximizes the number of pixels within trimmed image 534 corresponding to the iris and minimizes the number of pixels within trimmed image 534 that do not correspond to the iris. Certain functionality of image aligner 502 and image trimmer 504 may also be performed external to authentication software 206, such as within authentication device 104, without departing from the scope hereof.

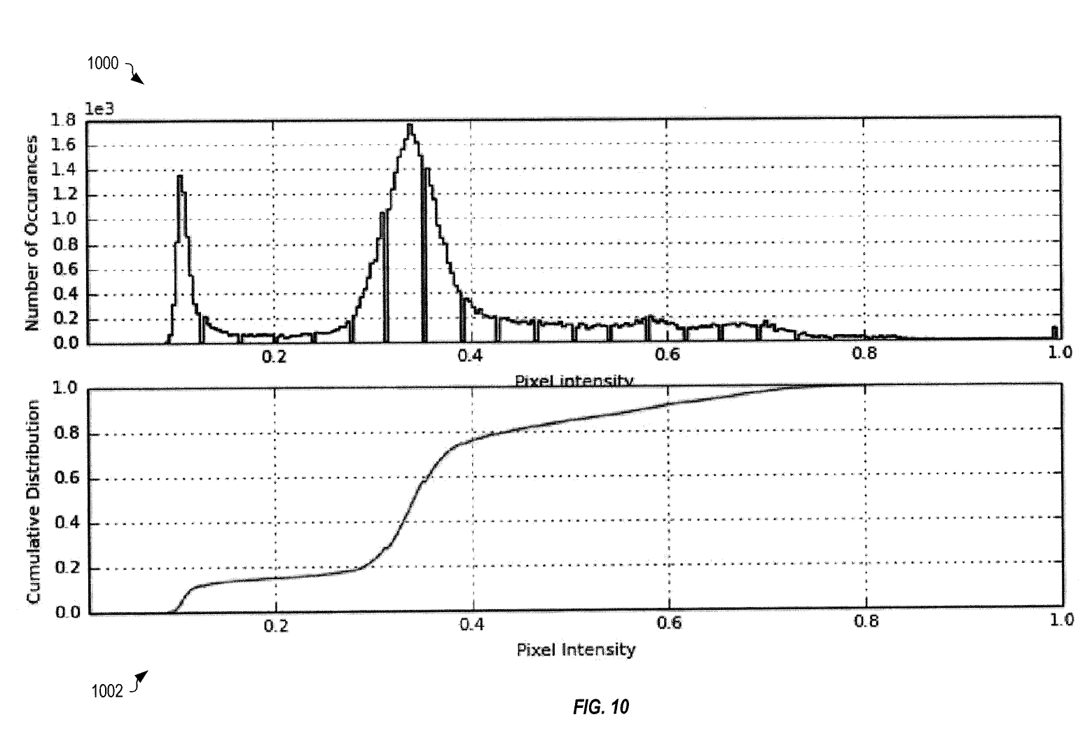

In step 606, method 600 normalizes the masked image relative to the master image and generates a normal image. In one example of step 606, image normalizer 506 generates a histogram 1000, FIG. 10, of pixel intensity and a cumulative distribution graph 1002 of trimmed image 534, and then adjusts intensity of pixels within trimmed image 534 to generate normal image 536, as shown in FIG. 11, such that a histogram of normal image 536 has a similar profile (shown as master profile 520) to that of the master image 116. This normalization adjustment of the image allows for variation in conditions when the image was captured, as compared to conditions when the master image was captures, and any variation between different cameras. For example, intensity of pixels within normal image 536 is adjusted by adding or subtracting a value until a histogram generated of normal image 536 matches a histogram of the associated master image 116. Optionally, in step 606, image normalizer 506 also stretches contrast of trimmed image 534 when generating normal image 536.

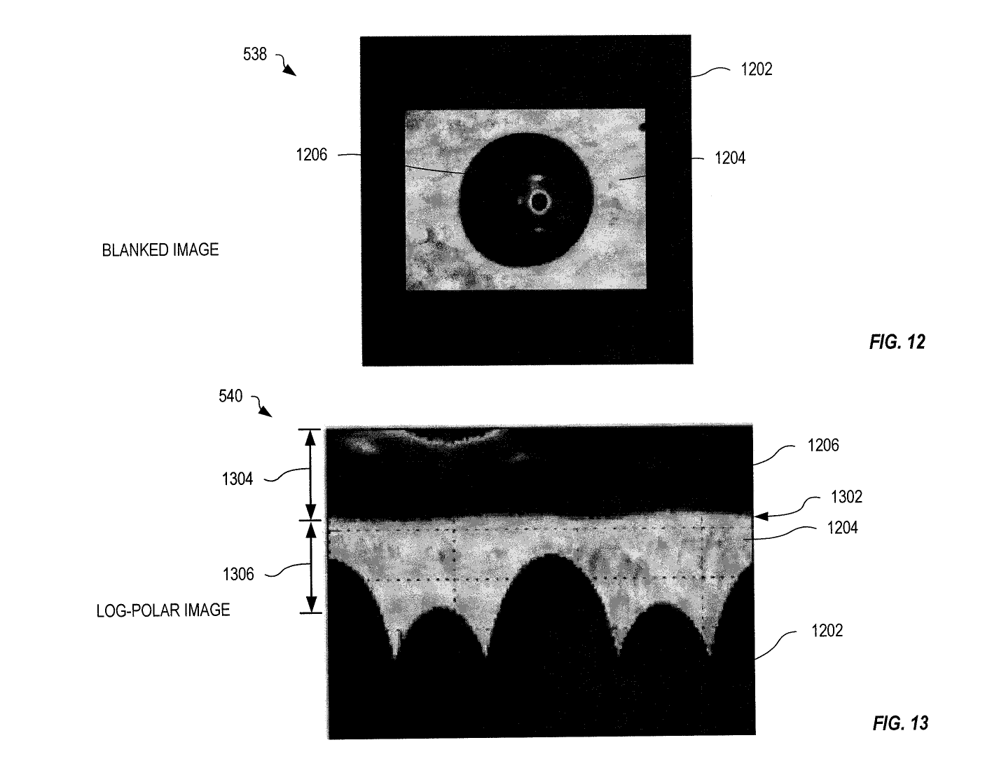

In step 608, method 600 blanks out unimportant parts of the normal image to generate a blanked image. In one example of step 608, image blanker 508 blanks out unimportant parts of normal image 536 to generate blanked image 538 as shown in FIG. 12. As shown in FIG. 12, a blanked portion 1202 leaves only part of iris 1204 and pupil 1206. In one embodiment, a predefined mask 509 that is shaped to selectively blank out flesh, eyelashes, etc. is applied to normal image 536 to generate blanked image 538. In another embodiment, image blanker 508 analyzes normal image 536 and dynamically adjusts mask 509 such that unwanted portions of normal image 536 are omitted from blanked image 538 while retaining all pixels corresponding to the iris. For example, image blanker 508 may generate mask 509 based upon a determined circular outer contour of the iris within normal image 536, such that use of mask 509 results in a circular portion of normal image 536 remaining within blanked image 538. In a further embodiment, image blanker 508 processes normal image 536 to identify pixels within the outer circumference of the iris of normal image 536 that are not of the iris, such as images of the eyelid where the eye is partially closed and images of eyelashes, and further modifies mask 509 to eliminate these pixel areas from blanked image 538. A similar mask 509′ is generated when processing master image 116, and masks 509 and 509′ are ORed together such that only areas of the iris that are common to test image 110 and master image 116 remain within blanked image 538. This may result in pixels of the iris being ignored in one or both of test image 110 and master image 116.

In step 610, method 600 converts the blanked image into a log/polar image. In one example of step 610, image converter 510 transforms blanked image 538 into log/polar image 540, an example of which is shown in FIG. 13, using a log/polar conversion algorithm. As shown in FIG. 13, when aligned image 532 has pupil 1206 correctly centered, the transformation of blanked image 538 into log/polar image 540 results in a substantially straight boundary 1302 between iris 1204 and pupil 1206, since pupil 1206 is substantially circular. Straight boundary 1302 facilitates further isolation of iris 1204. In the embodiment where image blanker 508 utilizes a circular mask, a lower boundary of the iris 1204 portion of log/polar image 540 will also be substantially straight, thereby further facilitating isolation of the iris 1204.

Variation in dilation of the pupil in captured images affects the amount of iris visible in that image. For example, as shown in FIG. 13, a distance 1304 corresponds to the size (e.g., radius) of the pupil within blanked image 538. The larger the size of the pupil, the greater distance 1304 becomes. Thus, the corresponding height 1306 of iris 1204 within log/polar image 540 is reduced as compared to an image captured when the pupil is less dilated. In one embodiment, image converter 510 expands iris 1204 within the area bounded by height 1306 to match a corresponding height of the iris within master image 116. In an alternate embodiment, image converter 510 may temporarily reduce the height of master image 116 to match height 1306.

The following exemplary pseudo code may be implemented within image converter 510 and/or iris isolator 512 to stretch (based upon interpolation such as linear, bi-cubic, etc.) log/polar image 540 to match log/polar image 540′ derived from master image 116:

for each column of log/polar image 540 and log/polar image 540′:

```
find top most row (r1) of the lower masked region in the current column of
  log/polar image 540;
find top most row (r2) of the lower masked region in the current column of
  log/polar image 540′;
if r1>r2,
  stretch the current column of log/polar image 540′ “down”
elseif r2>r1
  stretch the current column of log/polar image 540 “down”
else
  // do nothing, columns already match
```

At the end of this process, log/polar images 540, 540′ match one another in size, thereby improving consistency in match value 118.

Optionally, where boundary 1302 is not straight, as results when the pupil of blanked image 538 is not perfectly centered, image converter 510 may first straighten boundary 1302 by sliding each column of pixels within log/polar image 540 up or down as required to make boundary 1302 straight.

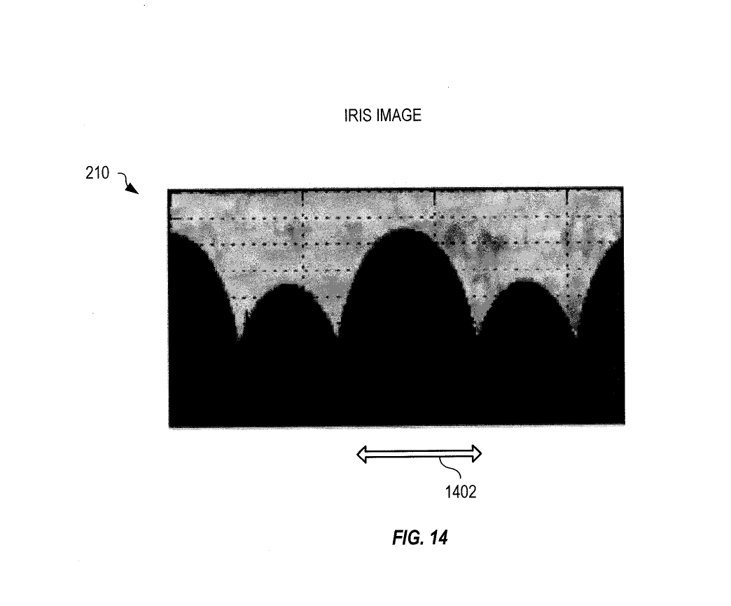

In step 612, method 600 isolates the iris within the log/polar image to generate an iris image. In one example of step 612, iris isolator 512 determines straight boundary 1302 within log/polar image 540 and trims off the top part of log/polar image 540 to form iris image 210 as shown in FIG. 14. In the embodiment where image blanker 508 utilizes a circular mask, iris isolator 512 determines straight boundary 1302 and the lower boundary within log/polar image 540 and trims off the top part and the lower part of log/polar image 540 to form iris image 210.

Step 614 is optional. If included, in step 614, method 600 shifts iris image 210 to generate a shifted image that aligns one or more identified features within corresponding features within master image 116. In one example of step 614, feature shifter 514 first identifies significant features within iris image 210, and then attempts to match (e.g., pattern matching) these features with significant features within master image 116 by generating an angular shifted image 542 (shifting as indicated by arrow 1402 within a predefined range, which corresponds to angular rotation of the imaged eye) from iris image 210 until a best match is determined. Where a match is not found, secure authentication server 102 may determine that iris image 210 does not match master image 116.

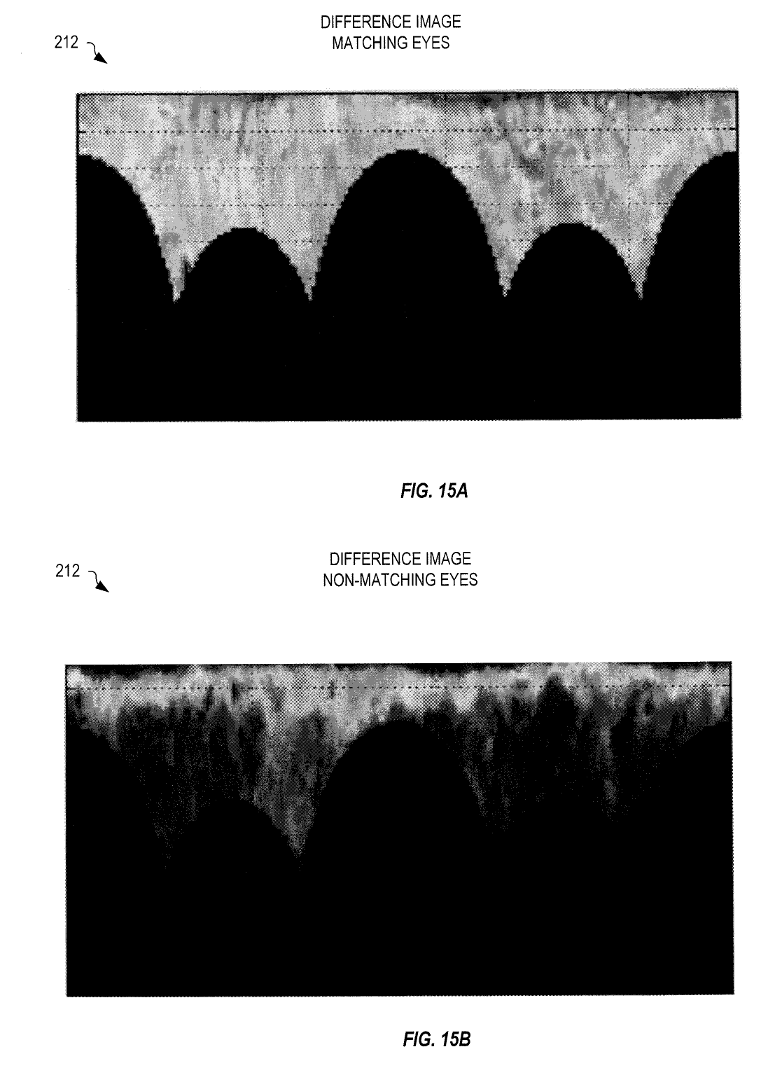

In step 616, method 600 digitally subtracts the iris image (or angular shifted image if generated) from a corresponding iris image (or angular shifted image) of master image 116 to generate a difference image. In one example of step 616, digital subtractor 516 subtracts iris image 210 (or angular shifted image 542 if generated) from iris image 210′ to generate difference image 212, a matching example of which is shown in FIG. 15A and a non-matching example of which is shown in FIG. 15B. Specifically, in FIGS. 15A and 15B, the lighter intensity within the area corresponding to iris 1204, the closer the match in the images.

In step 618, method 600 calculates a match value indicative of a match between the eye within the test image and the eye within the master image. That is, the match value provides an indication of whether the person presenting the eye within test image 110 is the same as the person whose eye was captured within master image 116. In one example of step 618, match calculator 518 processes difference image 212 to sum pixel values corresponding to the area of iris 1204, wherein the greater the value the greater the indication of a poor match between the captured eyes of test image 110 and master image 116.

As noted above, processing of master image 116 may be done concurrently by steps 602, 604, 608, 610, and 612 of method 600 such that steps 614 and 616 process images of corresponding sizes. Where multiple images are captured for each eye of individual 108 by secure identification device 150, method 600 may be used to determine a confidence and/or quality level of the captured master images 116 for the individual. For example, method 600 may determine a match value 118 for pairs of the captured images to determine which one or more of the images is best used as master image 116.

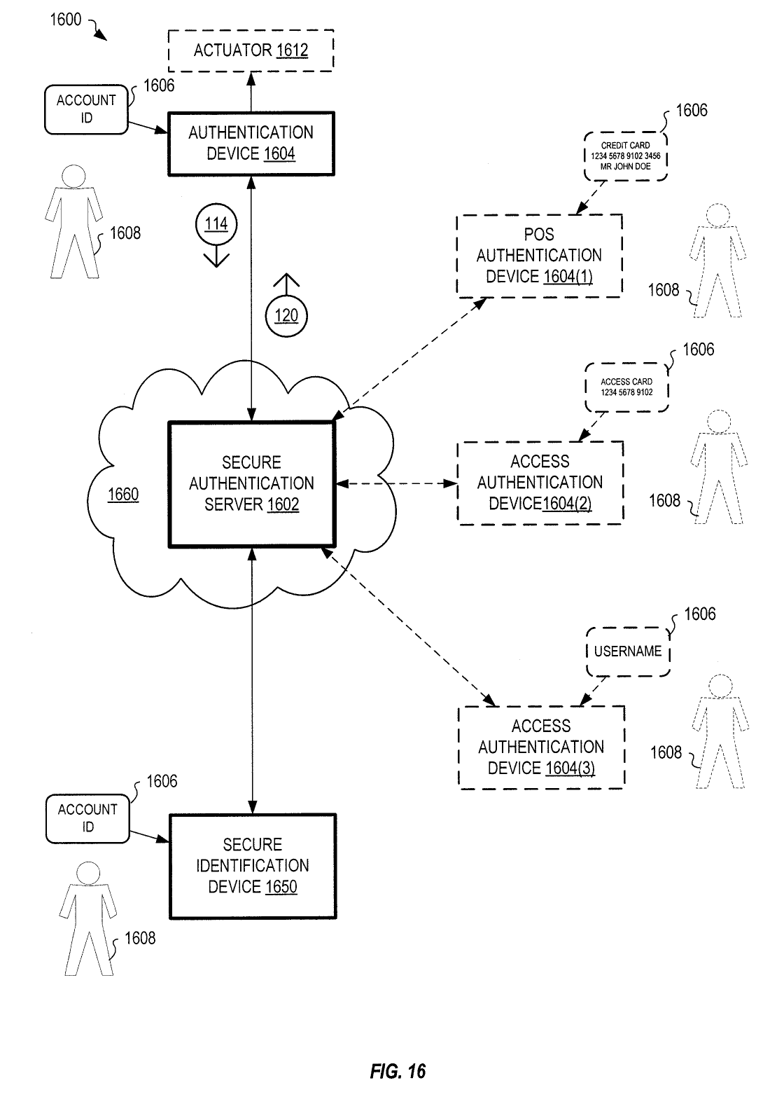

FIG. 16 shows one exemplary system 1600 for implementing unique identification of an individual 1608 as a service. System 1600 includes a secure authentication server 1602 located within the cloud 1660 (e.g., implemented as a remote computer networking service) and in communication with at least one authentication device 1604. Authentication device 1604 is remote from server 1602 and connects to server 1602 via one or more wired and/or wireless computer networks that may include the Internet.

Authentication device 1604 may also communicate with an actuator 1612, external to system 1600, which performs a certain function in response to identification of an individual by system 1600. For example, actuator 1612 may control opening of a door, payment of money, computer access (e.g., login authorization), and so on. In one embodiment, authentication device 1604 and actuator 1612 are combined into a single unit. Authentication device 1604 includes a biometric imager (e.g., a scanner and/or a camera) for capturing an image 1610 of a biometric feature (e.g., an iris, a finger print) of individual 1608. Authentication device 1604 also receives (e.g., from actuator 1612 or using a scanner within authentication device 1604) an account ID 1606 for which identification of individual 1608 is required.

System 1600 may also include a secure identification device 1650 that is similar to authentication device 1604 but is operated under greater security, such as within a secure and/or trusted area 1670. Secure identification device 1650 is used by an authorized operator to capture a biometric master image 1616 of individual 1608 and account ID 1606, and stores biometric master image 1616 within server 1602 in association with account ID 1606. That is, account ID 1606 may be used to identify biometric master image 1616 within server 1602.

Upon receiving request 1614, secure authentication server 1602 retrieves master image 1616 based upon account ID 1606 and processes image 1610 against master image 1616 to determines a match value 1618 that is indicative of confidence in image 1610 matching master image 1616. In one embodiment, match value 1618 is a percentage where 100% indicates absolute confidence that image 1610 matches master image 1616 and 0% indicates no confidence that image 1610 matches master image 1616. Thus, match value 1618 defines confidence in individual 1608 being present at authentication device 1604. Authentication device 1604 may provide match value 1618, or a representation thereof, to actuator 1612, wherein actuator 1612 may, or may not take further action, based upon this confidence.

In one example of operation, authentication device 1604 captures biometric image 1610 of individual 1608, receives associated account ID 1606, and forms an identification request 1614 that is sent to secure authentication server 1602. Server 1602 compares biometric image 1610 of request 1614 with a biometric master image 1616, retrieved based upon its association with account ID 1606, to determine a match value 1618. Server 1602 then sends, in reply to request 1614, an authentication response 1620 indicative of match value 1618 to authentication device 1604. Authentication device 1604 sends match value 1618, or a representation thereof, to actuator 1612, which in turn performs an action (e.g., opens a door) that requires unique identification of individual 1608 when match value 1618 indicate a sufficient probability that individual 1608 is present at authentication device 1604.

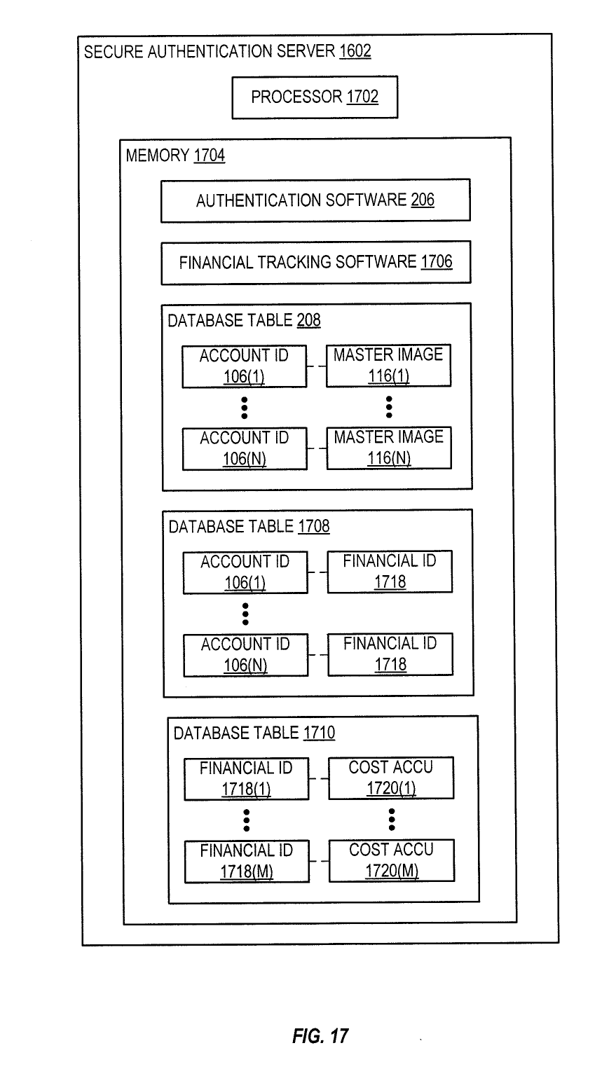

FIG. 17 shows the cloud based secure authentication server 1602 of system 1600 of FIG. 16 in further exemplary detail. Server 1602 uses authentication software 206 of FIG. 2, as described in detail in method 600 of FIG. 6, to match scanned test images with master images 116 stored within database table 208 in association with account IDs 106. Memory 1704 further includes a database table 1708 for determining a financial ID 1718 associated with an account ID 106, and a database table 1710 for accumulating cost of an entity associated with the financial ID using system 1600 as a service. In one example of operation, each time server 1602 is invoked to match test image 110 to master image 116 using authentication software 206, financial tracking software 1706 utilizes account ID 106, received from authentication device 1604, to identify an associated financial ID 1718 within database table 1708 and then accumulates a cost for the service within an cost accumulator 1720 associated with the financial ID 1718 within database table 1710.

Each financial ID 1718 identifies a business entity, such as a bank, a credit company, a supermarket chain, a private business, and so on. In one example of operation, each match operation adds a cost of $0.01 to a cost accumulator 1720 associated with the identified financial ID 1718. A financial value accumulated within cost accumulators 1720 may be periodically billed to the associated entity, and cost accumulators 1720 cleared upon receipt of payment for example.

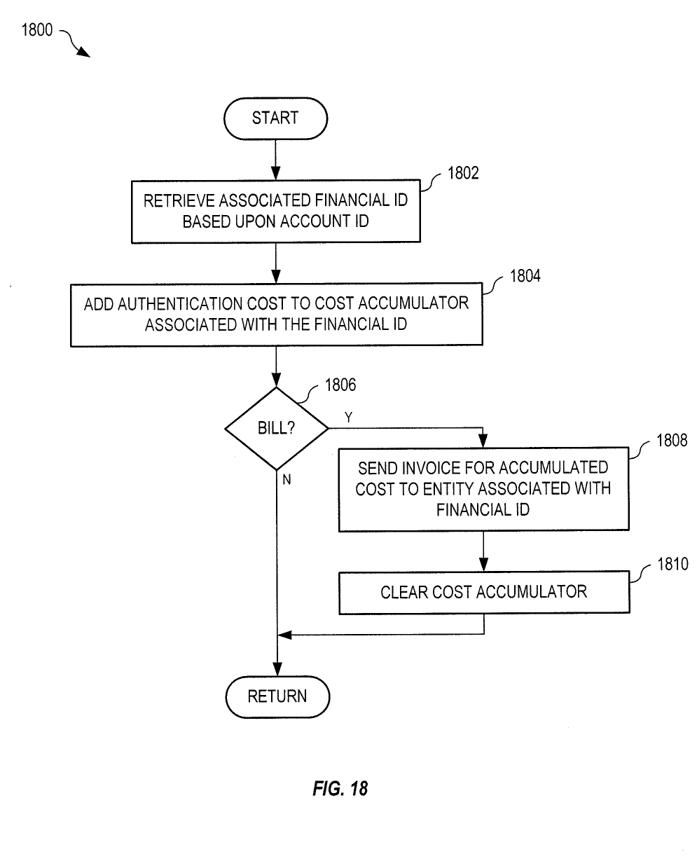

FIG. 18 is a flowchart illustrating an exemplary method 1800 for accumulating a cost representative of a service provided by system 1600 of FIG. 16. Method 1800 is for example implemented within financial tracking software 1706 of secure authentication server 1602 and is invoked from authentication software 206 for each received authentication request 114. In one embodiment, method 1800 is invoked only authentication requests 114 that result in a probability of a successful match (e.g., that the test image matches the master image).

In step 1802, method 1800 retrieves an associated financial ID based upon an account ID indicated by authentication software 206. In one example of step 1802, financial tracking software 1706 accesses database table 1708 to determine financial ID 1718 based upon account ID 106 provided by authentication software 206 as received within authentication request 114.

In step 1804, method 1800 adds the authentication cost to a cost accumulator associated with the financial ID determined in step 1802. In one example of step 1804, financial tracking software 1706 adds $0.01 to cost accumulator 1720(1) associated with financial IS 1718(1) within database table 1710. The cost per authentication may be set by an administrator of system 1600, or may be stored in association with each financial ID 1718, where the cost for each entity is set independently.

Step 1806 is a decision. If, in step 1806, method 1800 determines that the accumulated cost should be billed to the entity, method 1800 continues with step 1808; otherwise method 1800 terminates. In step 1808, method 1800 sends an invoice for the accumulated cost to the entity associated with the financial ID determined in step 1802. In one example of step 1808, financial tracking software 1706 initiates generation of an invoice to a credit card company associated with financial ID 1718(1) for an amount accumulated within cost accumulator 1720(1). In step 1810, method 1800 clears the cost accumulator. In one example of step 1810, financial tracking software 1706 subtracts a payment value from cost accumulator 1720(1) when payment is received from the entity associated with financial ID 1718(1). Method 1800 then terminates.

As shown in FIG. 1, system 100 may be implemented under control of a single entity, where secure authentication server 102 and secure identification device 150 are deployed local to that entity, and where authentication devices 104 are deployed either local to secure authentication server 102 (e.g., within the same building) or remotely (e.g., connected via a network or interne connection) from server 102. As shown in FIG. 16, server 1602 may be deployed within cloud 1660, wherein one or more of authentication devices 1604 and secure identification devices 1650 may be deployed at an entity location and/or remotely therefrom. That is, system 100 may be purchased whereas operated by one entity, and system 1600 may provide a service to one or entities. However, other configurations are possible, such a where server 1602 is implemented within the cloud and authentication devices 1604 and one or more secure identification devices 1650 are purchased and used at specific entity locations. For example, server processing and authentication device deployment sale or rental may be tailored to requirements of each entity.

### Conformance to ISO/IEC Standards

Where appropriate, systems 100 FIG. 1 and system 1600 FIG. 16 may be configured to conform to one or more industry standards. The ISO/IEC 19794-6 iris standard publication was established in late 2011. The iris standard can support PIV (Personal Identity Verification) authentication and other Iris standards published within the ISO and NIST organizations. Conformance to ISO/IEC 19794-6:2011 address Level 1 and Level 2 conformance. There is effort to establish semantic testing of Type 3 and Type 7 formats within this standard. Type 3 provides a standard for centering and margins. Type 7 formats Eyelid detection, blurring of the boundary and conformance of compact iris image implementations. An evaluation based program for development of clear, implementable, and interoperable iris quality standard ISO/IEC 29694-6 has been created to establish requirements on software or hardware capturing iris image. This ISO standard uses a refined list of image properties affecting iris recognition performance.

### Measuring Performance

Systems 100 and 1600 may also track their matching performance by using industry standards for scoring, such as false acceptance rate (FAR) and false rejection rate (FRR), and so on.

### Exemplary Uses

The following list provides examples of where system 100 and/or system 1600 may be used for ID authentication.
Memory-deficient, memory challenged, and/or handicapped patients may be identified when lost based upon previously recorded biometric images and returned to their residency.
Missing children may be identified when found based upon previously recorded biometric information; a faster solution that DNA and finger print testing.
Conference attendees may register a biometric image and thereby automatically sign-in at a conference.
Healthcare records may be matched to an individual using previously recorded biometric images to ensure correct identification of the individual when accessing medical records.
Credit card swipes on a portable device (e.g., a smart phone)—Similar to the above described Credit Card authentication but portable, wherein server 1602 is accessed from a portable device.
Voting and Exam/Testing may be identified using biometric images previously stored to eliminate fraudulent voting and testing.
Tax preparers and filers may be identified by previously recorded biometric images to prevent fraudulent use of a Social Security Number and PIV.
Devices with parental control may identify an individual to prevent a minor from accessing and/or using the device (e.g., Cable TV and Internet Access device).
Insurance applicants may be identified based upon previously recorded biometric images to eliminate Insurance Fraud, since an Insurance Company may certain with whom they are dealing.
Pharmaceutical distributors may be identified by previously stored biometric images to prevent illegal use and distribution of drugs in the Pharmaceutical industry.
Weaponry may be secured by identifying an individual intending to use the weapon based upon previously recorded biometric images, wherein only the person with the registered Iris can activate the Weapon.
Authorized and adult individuals may be identified using previously recorded biometric images to prevent unauthorized access to pornographic material, such as from the Internet, store purchases, and other electronic means.
Domestic Animal (pets) may be identified using previously stored biometric images obviating the need to use intrusive microchips.
Wild Animals (e.g.; IE bears, birds, tigers, endanger species, etc.) may be identified for the purpose of tracking migratory patterns.
Changes to biometric patterns of a patient may be monitored and/or identified over time, as is done within the optometry industry, without requiring visits to a specific office.
Deceased individuals may be identified, based upon previously recorded biometric images, even when other physical means cannot be used for identification.
Criminals and Prisoners may be identified, based upon previously recorded biometric images, both within and outside the justice system.
Drivers may be identified, based upon previously recorded biometric images, to prevent fraudulent use of licenses as identification. Drivers may be recorded, tracked and authenticated in all 50 states of the U.S.A. without using a picture ID that can be forged.
Individuals (e.g., US citizens, legal aliens, illegal aliens and foreign nationals) may be identified and tracked based upon previously recorded biometric images, thereby improving security at border crossings and airports.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A secure authentication server for uniquely identifying an individual, comprising:
a processor; and
a memory storing machine readable instructions that are executable by the processor to provide the capability of:
receiving, from a remote authentication device, an authentication request comprising an account ID associated with the individual and a biometric test image captured of the individual;
digitally subtracting a master image, stored within the memory in association with the account ID, from the biometric test image to generate a high contract test image;
processing the high contract test image to determine a percentage match of the biometric test image to the master image; and
sending the percentage match to the remote authentication device.

2. The secure authentication server of claim 1, wherein the percentage match is indicative of the unique identification of the individual.

3. An authentication device for uniquely identifying an individual, comprising:
a processor;
a memory, communicatively coupled with the processor, storing machine readable instructions that when executed by the processor provide the authentication device capable of:
receiving an account ID corresponding to the individual requiring authentication;
capturing a biometric image of the individual;
sending the account ID and the biometric image to a remote authentication server; and
receiving, from the remote authentication server, a match value indicative of confidence in the individual matching the account ID.

4. The authentication device of claim 3, further comprising an output for triggering an external device based upon the match value and a pass/fail threshold.

5. The authentication device of claim 4, wherein the threshold is dynamically adjusted based upon a determined confidence requirement of the authentication.

6. A method for uniquely identifying an individual, comprising:
receiving, from a remote authentication device, an authentication request comprising an account ID associated with the individual and a biometric test image captured of the individual;
processing a master image, stored within the memory in association with the account ID, and the biometric test image to determine a match value; and
sending the match value to the remote authentication device.

7. The method of claim 6, further comprising:
storing, when the percentage match is greater than a predefined threshold, the biometric test image within the memory in association with the account ID and a date stamp; and
processing the master biometric image and at least one of the stored biometric test images to provide an indication of change in health of the individual.

8. The method of claim 6, the step of processing comprising aligning the image based upon a determined center of a pupil in the image to generate an aligned image.

9. The method of claim 8, the step of processing comprising masking the aligned image to generate a masked image.

10. The method of claim 9, the step of processing comprising normalizing the masked image based upon a histogram of the master image to generate a normal image.

11. The method of claim 10, the step of processing comprising converting the normal image into a log/polar image.

12. The method of claim 11, the step of processing comprising eliminating imagery outside of the iris within the log/polar image to generate an iris image.

13. The method of claim 12, the step of eliminating comprising one or both of masking and trimming the log/polar image.

14. The method of claim 12, the step of processing comprising stretching, to compensate for pupil dilation, the log/polar image to generate an iris image.

15. The method of claim 14, the step of processing comprising subtracting the iris image from a corresponding iris image generated from the master image to generate a difference image.

16. The method of claim 15, the step of processing comprising summing pixel values within the difference image to generate the match value.

17. A method for uniquely identifying an individual, comprising:
capturing, within an authentication device, a biometric image of the individual;
encrypting the biometric image and an associated account ID in an authentication request message;
sending the authentication request message from the authentication device to an authentication server that is remote from the authentication device;
receiving, within the authentication device, an authentication response from the authentication server;
decrypting the authentication response to determine a match result; and
outputting a signal indicative of the match value being greater than a predefined threshold.

18. The method of claim 17, wherein the output signal triggers a device external to the authentication device.

19. A method for providing a service for individual identification, comprising:
receiving, within a server and from a remote authentication device, an authentication request message containing a test biometric image and an account ID;
retrieving a master biometric image from a database of the server based upon the account ID;
determining a match value indicative of a percentage match between the test biometric image and the master biometric image;
sending to the remote authentication device, in reply to the authentication request message, the match value; and
adding, within the server, a cost value to a cost accumulator associated with a client.

20. The method of claim 19, further comprising periodically receiving payment from the client based upon the cost accumulator.
